(19) United States
(12) Patent Application Publication
(10) Pub. No.: US 2025/0149218 A1
(43) Pub. Date: May 8, 2025

(54) INDUCTOR COMPONENT

(71) Applicant: Murata Manufacturing Co., Ltd., Kyoto-fu (JP)

(72) Inventor: Tetsurou KAWAKAMI, Nagaokakyo-shi (JP)

(73) Assignee: Murata Manufacturing Co., Ltd., Kyoto-fu (JP)

(21) Appl. No.: 18/937,505

(22) Filed: Nov. 5, 2024

(30) Foreign Application Priority Data
Nov. 6, 2023 (JP) 2023-189500

(51) Int. Cl. H01F 5/04; H01F 5/06; H01F 17/02

(52) U.S. Cl. CPC H01F 5/04; H01F 5/06; H01F 17/02

(57) ABSTRACT

An inductor component includes an insulating body, and a coil inside the body and wound around an axis. The coil includes a first coil wiring layer that extends in a direction intersecting with a first direction parallel to the axis, and a second coil wiring layer that is away from the first coil wiring layer in an axis direction and extends in a direction intersecting with the axis direction. The first and second coil wiring layers configure a facing portion in which they face each other with an interlayer insulating portion, which is part of the body, between them. In a cross section, of the facing portion, orthogonal to an extending direction of the first coil wiring layer, the first coil wiring layer has a first upper surface that is on an interlayer insulating portion side.

### CROSS-REFERENCE TO RELATED APPLICATION

This application claims benefit of priority to Japanese Patent Application No. 2023-189500, filed Nov. 6, 2023, the entire content of which is incorporated herein by reference.

### BACKGROUND

### Technical Field

The present disclosure relates to an inductor component.

### Background Art

Conventionally, as an inductor component, for example, there is the inductor component described in Japanese Unexamined Patent Application Publication No. 2020-194976. The inductor component described in Japanese Unexamined Patent Application Publication No. 2020-194976 includes a coil disposed inside an insulating body. The coil includes, for example, a plurality of coil wiring layers that is stacked with insulating layers interposed therebetween. These coil wiring layers are electrically connected through via conductors provided in the insulating layers.

### SUMMARY

The inductor component of Japanese Unexamined Patent Application Publication No. 2020-194976 has room for improvement in terms of further enhancing insulation reliability between two coil wiring layers stacked inside the body.

Therefore, the present disclosure provides an inductor component capable of further enhancing insulation reliability between two stacked coil wiring layers.

An inductor component according to an aspect of the present disclosure includes an insulating body, and a coil disposed inside the body and wound around an axis, and the coil includes a first coil wiring layer that extends in a direction intersecting with a first direction parallel to the axis, and a second coil wiring layer that is disposed away from the first coil wiring layer in the first direction and extends in the direction intersecting with the first direction. The first coil wiring layer and the second coil wiring layer configure a facing portion in which the first coil wiring layer and the second coil wiring layer face each other with an interlayer insulating portion interposed therebetween. The interlayer insulating portion is a part of the body, and in a cross section, of the facing portion, orthogonal to an extending direction of the first coil wiring layer, the first coil wiring layer has a first upper surface that is located on an interlayer insulating portion side and that is formed from a curved surface recessed from both edges of the first upper surface in a direction opposite to the second coil wiring layer in the first direction.

According to the inductor component according to the present disclosure, insulation reliability between two stacked coil wiring layers can be enhanced.

### BRIEF DESCRIPTION OF THE DRAWINGS

FIG. 1A is a schematic see-through perspective view of an inductor component according to an embodiment of the present disclosure;

FIG. 1B is a schematic exploded perspective view of the inductor component of FIG. 1A;

FIG. 2 is a schematic sectional view orthogonal to an axis direction of the inductor component of FIG. 1A;

FIG. 3 is a schematic sectional view taken along line III-III illustrated in FIG. 2;

FIG. 4 is a schematic enlarged sectional view of a parallel arrangement portion illustrated in FIG. 3;

FIG. 5A is a schematic process sectional view illustrating a manufacturing method of the inductor component of FIG. 1A;

FIG. 5B is a schematic process sectional view illustrating the manufacturing method of the inductor component of FIG. 1A;

FIG. 5C is a schematic process sectional view illustrating the manufacturing method of the inductor component of FIG. 1A;

FIG. 5D is a schematic process sectional view illustrating the manufacturing method of the inductor component of FIG. 1A;

FIG. 6A is a schematic process sectional view illustrating another example of the manufacturing method of the inductor component of FIG. 1A;

FIG. 6B is a schematic process sectional view illustrating the other example of the manufacturing method of the inductor component of FIG. 1A;

FIG. 7A is a schematic process sectional view illustrating a manufacturing method of the inductor component of FIG. 1A;

FIG. 7B is a schematic process sectional view illustrating the manufacturing method of the inductor component of FIG. 1A;

FIG. 7C is a schematic process sectional view illustrating the manufacturing method of the inductor component of FIG. 1A;

FIG. 7D is a schematic process sectional view illustrating the manufacturing method of the inductor component of FIG. 1A;

FIG. 7E is a schematic process sectional view illustrating the manufacturing method of the inductor component of FIG. 1A;

FIG. 8 is a view illustrating an electron microscope image of a parallel arrangement portion of an inductor component of an example;

FIG. 9 is a view illustrating an electron microscope image of a connecting portion of the inductor component of the example;

FIG. 10 is a schematic sectional view of a parallel arrangement portion and a connecting portion of an inductor component of a reference example;

FIG. 11 is a view illustrating an electron microscope image of the parallel arrangement portion of the inductor component of the reference example; and

FIG. 12 is a view illustrating an electron microscope image of the connecting portion of the inductor component of the reference example.

### DETAILED DESCRIPTION

Hereinafter, an embodiment of the present disclosure will be described with reference to the drawings. Note that the present disclosure is not limited by the embodiment.

In addition, in the drawings, substantially the same members are denoted by the same reference numerals. For the purpose of illustration, the respective elements in the drawings may be exaggeratedly illustrated and are not necessarily consistent with the scales.

In addition, hereinafter, for convenience of explanation, a state at a time of ordinary use is assumed, and terms indicating directions such as “up”, “down”, “right”, “left”, and “side” are used, but do not indicate limiting a use state or the like of an inductor component according to the present disclosure.

### Embodiment

### (Overview of Inductor Component)

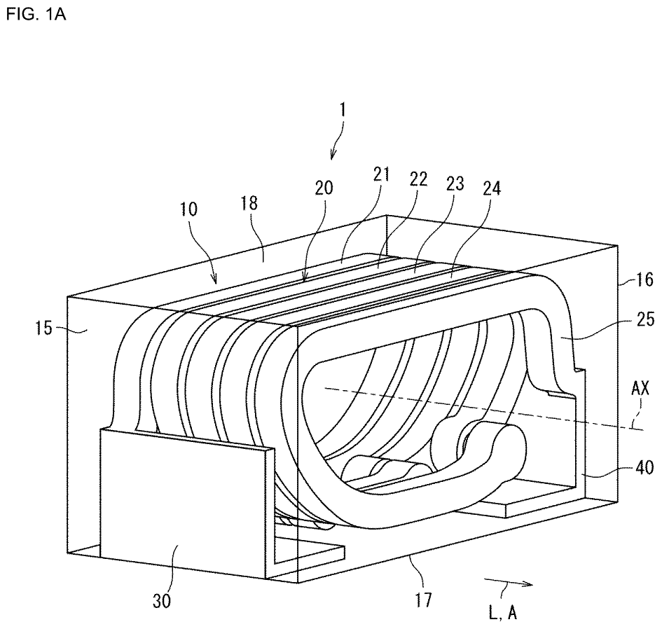

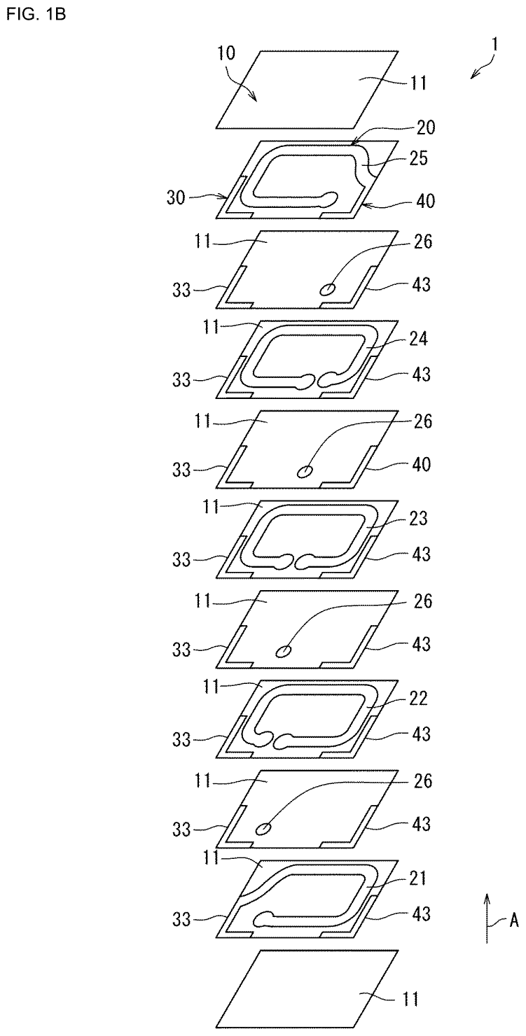

FIG. 1A is a see-through perspective view illustrating an embodiment of an inductor component. FIG. 1B is an exploded perspective view of the inductor component of FIG. 1A.

As illustrated in FIGS. 1A and 1B, an inductor component 1 includes an insulating body 10, a coil 20 provided inside the body 10, and a first outer electrode 30 and a second outer electrode 40 electrically connected to the coil 20. The inductor component 1 is electrically connected to wiring of a circuit board (not illustrated) through the first outer electrode 30 and the second outer electrode 40. In FIG. 1A, the body 10 is depicted as being transparent such that a structure can be easily understood.

As illustrated in FIG. 1A, the body 10 is formed into, for example, a substantially rectangular parallelepiped shape. A surface of the body 10 includes a first end surface 15, a second end surface 16 facing the first end surface 15, a bottom surface 17 connected between the first end surface 15 and the second end surface 16, and a top surface 18 facing the bottom surface 17.

The body 10 has a structure in which a plurality of insulating layers 11 is stacked in a stacking direction A, which is a thickness direction of the respective insulating layers 11. In this example, the first end surface 15, the second end surface 16, the bottom surface 17, and the top surface 18 of the body 10 illustrated in FIG. 1A are surfaces parallel to the stacking direction A. In addition, the bottom surface 17 side is a mounting surface of the inductor component 1 for a circuit board or the like. In the specification, “being parallel” may be substantially parallel and includes a case of being approximately parallel in consideration of a realistic variation range.

Each of the insulating layers 11 contains, for example, a glass component and a filler component. The insulating layer 11 may be a layer that is formed using a photosensitive insulating paste. As a result, patterning can be performed on the insulating layer 11 by photolithography. Note that there is a case in which boundaries between the plurality of insulating layers 11 are not clear due to firing or the like.

The first outer electrode 30 and the second outer electrode 40 contain a conductive material such as Ag or Cu. The first outer electrode 30 and the second outer electrode 40 may be composed of a conductive material and glass particles. In the illustrated example, the first outer electrode 30 has an L-shape provided from a part of the first end surface 15 onto a part of the bottom surface 17. The second outer electrode 40 has an L-shape provided from a part of the second end surface 16 onto a part of the bottom surface 17.

The coil 20 contains a conductive material. The coil 20 may be composed of, for example, similar materials to those of the first outer electrode 30 and the second outer electrode 40. The coil 20 is helically wound around an axis AX. The coil 20 is formed into, for example, a substantially elliptic shape when viewed in an axis direction L. The “axis direction L” is a direction parallel to the axis (a central axis of a helical shape) AX around which the coil 20 is wound. The axis direction L may be referred to as a “first direction”. In this example, the axis direction L of the coil 20 indicates the same direction as the stacking direction A of the insulating layers 11. Note that the shape of the coil 20 viewed in the axis direction L is not limited to an elliptic shape and may be a circular shape, an oval shape, a rectangular shape, or other polygonal shapes.

One end portion of the coil 20 is connected to the first outer electrode 30, and another end portion of the coil 20 is connected to the second outer electrode 40. In the illustrated example, the coil 20, the first outer electrode 30, and the second outer electrode 40 are integrally formed and clear boundaries do not exist. Note that the coil and the outer electrodes may be formed of different materials or by different construction methods.

The coil 20 has a plurality of coil wiring layers 21 to 25 disposed away from each other in the axis direction L. A connection conductor 26 is disposed between two adjacent coil wiring layers. In the present embodiment, each of the plurality of coil wiring layers 21 to 25 and each of the plurality of connection conductors 26 are disposed (embedded) inside a corresponding one of the insulating layers 11.

Each of the coil wiring layers 21 to 25 extends in a direction intersecting with (here, orthogonal to) the axis direction (the first direction parallel to the axis AX) L. In the specification, “being orthogonal” may be substantially orthogonal and includes a case of being approximately orthogonal with respect to the axis direction L in consideration of a realistic variation range. In the illustrated example, the number of turns of the respective coil wiring layers 21 to 25 is less than one. In the present embodiment, at least a part of one coil wiring layer (for example, the coil wiring layer 21) of two coil wiring layers adjacent to each other in the axis direction L faces another coil wiring layer (for example, the coil wiring layer 22) with an interlayer insulating portion, which is a part of the body 10, interposed therebetween. In the example illustrated in FIGS. 1A and 1B, two adjacent coil wiring layers have a portion in which the two adjacent coil wiring layers face each other with an interlayer insulating portion interposed therebetween and extend in the same direction. In the specification, a portion in which two coil wiring layers adjacent to each other face in the axis direction L with an interlayer insulating portion interposed therebetween is referred to as a “facing portion”. A portion, of the facing portion, in which the two coil wiring layers face each other with an interlayer insulating portion interposed therebetween and extend in the same direction (being arranged in parallel) is referred to as a “parallel arrangement portion”.

Each of the connection conductors 26 is disposed so as to electrically connect, in series, a part of one coil wiring layer of two coil wiring layers adjacent to each other in the axis direction L to a part of another coil wiring layer. In the specification, a portion where the two coil wiring layers adjacent to each other in the axis direction L are electrically connected to each other with a connection conductor interposed therebetween is referred to as a “connecting portion”.

As described above, the plurality of coil wiring layers 21 to 25 is electrically connected to each other in series with a corresponding one of the connection conductors 26 interposed therebetween and also constitutes the coil 20 having, for example, a helical shape. The coil wiring layer 21, which is the lowermost layer, is connected to the first outer electrode 30. The coil wiring layer 25, which is the uppermost layer, is connected to the second outer electrode 40.

Hereinafter, more detailed structures of the facing portion (parallel arrangement portion) and the connecting portion will be described using the two coil wiring layers 21 and 22 adjacent to each other in the axis direction L as examples. In the following description, the layer (here, the coil wiring layer 21), of the two adjacent coil wiring layers, located on the lower side in the stacking direction A is referred to as a “first coil wiring layer”, and the layer (here, the coil wiring layer 22) located above the first coil wiring layer is referred to as a “second coil wiring layer”.

### (Parallel Arrangement Portion)

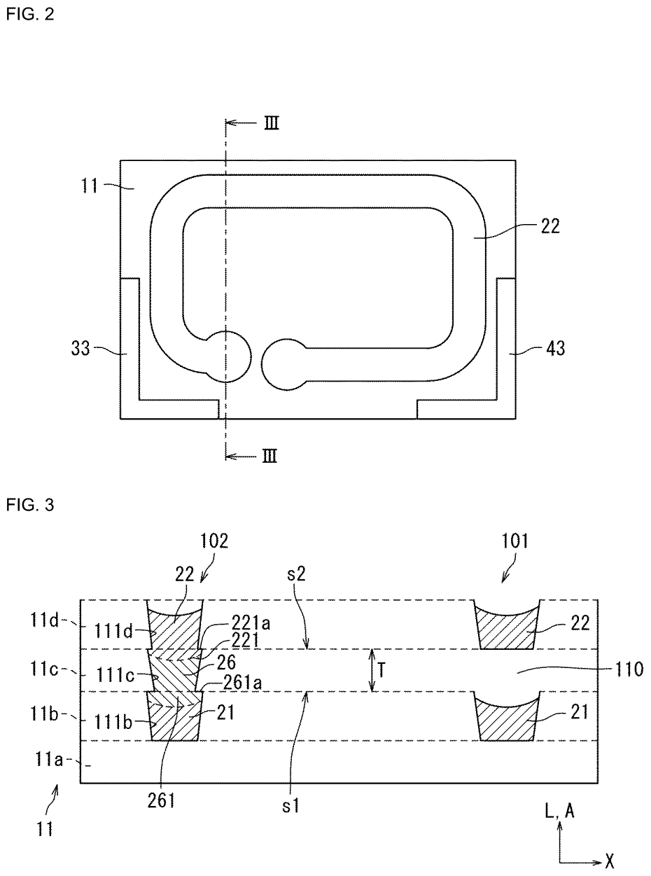

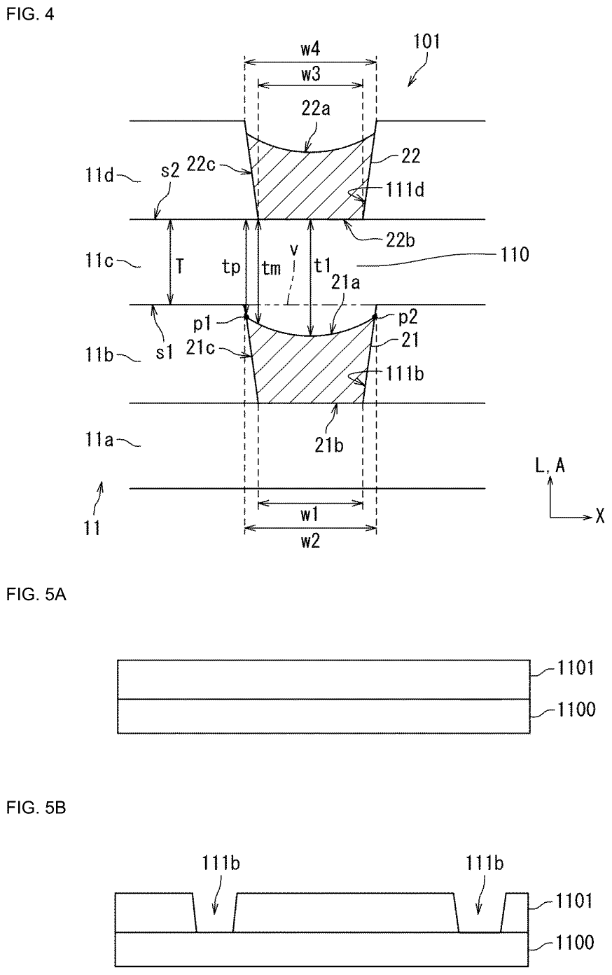

FIG. 2 is a schematic sectional view orthogonal to the axis direction L in the inductor component 1 illustrated in FIG. 1A and illustrates a cross section including an upper surface of the second coil wiring layer. FIG. 3 is a schematic enlarged sectional view taken along line III-III illustrated in FIG. 2 and illustrates a parallel arrangement portion and a connecting portion in the inductor component 1. FIG. 4 is an enlarged sectional view illustrating only the parallel arrangement portion illustrated in FIG. 3. FIGS. 3 and 4 illustrate cross sections orthogonal to the extending direction of the first and second coil wiring layers. An X direction illustrated in FIGS. 3 and 4 is a direction orthogonal to the extending direction of the first and the second coil wiring layers and the axis direction L.

FIGS. 3 and 4 illustrate only four insulating layers 11a to 11d of the plurality of insulating layers 11 constituting the body 10. The insulating layers 11a to 11d are stacked in this order in the stacking direction A (here, in the axis direction L). In the illustrated example, the thicknesses of the insulating layers 11a to 11d are made substantially equal for convenience, but the thicknesses of the insulating layers 11a to 11d can be appropriately set. For example, the insulating layer 11d may be thicker than the insulating layer 11b.

A parallel arrangement portion 101 includes the first coil wiring layer 21, the second coil wiring layer 22, and an interlayer insulating portion 110 located between the coil wiring layers 21 and 22.

As illustrated in FIG. 4, the first coil wiring layer 21 is disposed inside the insulating layer (hereinafter, “a first insulating layer”) 11b. Here, the first coil wiring layer 21 is disposed inside a first hole 111b formed in the first insulating layer 11b. The first hole 111b is, for example, a through hole extending through the first insulating layer 11b in the axis direction L. Note that the first hole 111b may be a bottomed hole (a groove).

The second coil wiring layer 22 is disposed inside the insulating layer (hereinafter, “a second insulating layer”) 11d. Here, the second coil wiring layer 22 is disposed inside a second hole 111d formed in the second insulating layer 11d. The second hole 111d is, for example, a through hole extending through the second insulating layer 11d in the axis direction L.

The interlayer insulating portion 110 is, for example, a part of the insulating layer (hereinafter, “an intermediate insulating layer”) 11c. Note that the interlayer insulating portion 110 may include other interposing layers.

Each of the first coil wiring layer 21 and the second coil wiring layer 22 has, for example, a substantially rectangular (for example, an inverted trapezoidal) sectional shape. The first coil wiring layer 21 has a first upper surface 21a located on an upper side in the axis direction L (the second coil wiring layer 22 side), a first lower surface 21b located on a lower side in the axis direction L (on a side opposite to the first upper surface 21a side), and a first side surface 21c connecting the first upper surface 21a and the first lower surface 21b. Similarly, the second coil wiring layer 22 has a second upper surface 22a located on an upper side in the axis direction L (on a side opposite to the first coil wiring layer 21 side), a second lower surface 22b located on a lower side in the axis direction L (on the first coil wiring layer 21 side), and a second side surface 22c connecting the second upper surface 22a and the second lower surface 22b.

The first upper surface 21a of the first coil wiring layer 21 and the second lower surface 22b of the second coil wiring layer 22 face each other with the intermediate insulating layer 11c (the interlayer insulating portion 110) interposed therebetween. In the example illustrated in FIG. 4, at least a part of the first upper surface 21a and at least a part of the second lower surface 22b are in contact with the intermediate insulating layer 11c (the interlayer insulating portion 110).

In the present embodiment, in the cross section illustrated in FIG. 4, the first upper surface 21a of the first coil wiring layer 21 is formed from a curved surface recessed from both edges p1 and p2 of the first upper surface 21a toward a lower side in the axis direction L (a direction opposite to the second coil wiring layer 22).

In addition, the first upper surface 21a of the first coil wiring layer 21 is located further on a lower side than is an upper surface of the first insulating layer 11b in the axis direction L. That is, the entire portion of the first upper surface 21a of the first coil wiring layer 21 is located inside the first hole 111b of the first insulating layer 11b. Note that in the cross section illustrated in FIG. 4, the “upper surface of the first insulating layer 11b” is, for example, a first boundary s1 between the first insulating layer 11b and the intermediate insulating layer 11c. When the first boundary s1 is not easily visually recognized due to firing or the like, as described later, an imaginary line v obtained through extending of a first surface 261a (FIG. 3) of a connecting portion 102 in the X direction can be regarded as “a height of the first boundary s1”.

Since the first upper surface 21a of the first coil wiring layer 21 is located further on a lower side than is the upper surface of the first insulating layer 11b in the axis direction L, the thickness of the interlayer insulating portion 110 in the axis direction L is easily ensured. For example, a minimum thickness tm of the interlayer insulating portion 110 in the axis direction L can be made larger than a thickness T of the intermediate insulating layer 11c. In the example illustrated in FIG. 4, the minimum thickness tm is a distance from an edge of the second lower surface 22b to the first upper surface 21a, but the position that becomes the minimum thickness tm (a position in the X direction) can be changed depending on the shape of the second lower surface 22b. The “thickness T of the intermediate insulating layer 11c” indicates, for example, a distance from the first boundary s1 between the intermediate insulating layer 11c and the first insulating layer 11b to a second boundary s2 between the intermediate insulating layer 11c and the second insulating layer 11d in the axis direction L. When each of the boundaries s1 and s2 is not clear, for example, the distance (see FIG. 3) from the first surface 216a of the connecting portion 102 to a second surface 221a in the axis direction L can be regarded as the “thickness T”.

In the example illustrated in FIG. 4, at least a part of the interlayer insulating portion 110 (the intermediate insulating layer 11c) has a projecting portion that projects toward the insulating layer 11b side. The first upper surface 21a of the first coil wiring layer 21 is in contact with the projecting portion of the interlayer insulating portion 110. The “projecting portion” includes, for example, a portion, of the interlayer insulating portion 110, located inside the first hole 111b of the insulating layer 11b and above the first coil wiring layer 21 (on the insulating layer 11d side). The projecting portion may include a portion located between the imaginary line v described above and the first upper surface 21a of the first coil wiring layer 21.

On the other hand, the first lower surface 21b of the first coil wiring layer 21 is, for example, substantially flat. The first lower surface 21b may substantially flush with the lower surface of the first insulating layer 11b.

The first side surface 21c of the first coil wiring layer 21 is smooth. A “smooth” surface is not limited to a flat surface and includes a curved surface. In addition, the surface may be substantially smooth and indicates, for example, the first side surface 21c being a surface not having a protruding portion (see FIGS. 10 to 12 described later) projecting in a direction intersecting with the axis direction L.

In the cross section exemplified in FIG. 4, the thickness of a central portion, of the first coil wiring layer 21, including the bottom portion of the recessed curved surface in the axis direction L is smaller than the thickness of a portion located on each side of the central portion in the X direction (for example, a portion located near the first side surface 21c). As a result, a portion, of the first coil wiring layer 21, located on a coil inner diameter side where a current easily concentrates can be made thicker than the central portion. The “portion located on a coil inner diameter side” indicates, for example, a portion, of the two first side surfaces 21c of the first coil wiring layer 21, located near the side surface located on an inner side of the coil 20.

In the present embodiment, a width w2 of the first upper surface 21a of the first coil wiring layer 21 is larger than a width w1 of the first lower surface 21b. In the specification, a width of an upper surface (or a lower surface) of a coil wiring layer indicates a width of the upper surface (or the lower surface) in a direction (the X direction) orthogonal to the axis direction L. Therefore, the shape of a cross section orthogonal to an extending direction of the first coil wiring layer 21 is substantially inverted trapezoidal.

The second coil wiring layer 22 may also have a similar sectional shape to the first coil wiring layer 21. In this example, the second upper surface 22a of the second coil wiring layer 22 is formed from a recessed curved surface and located further on a lower side than is the upper surface of the second insulating layer 11d. The second lower surface 22b is, for example, substantially flat, and the second side surface 22c is substantially smooth. A width w4 of the second upper surface 22a is larger than a width w3 of the second lower surface 22b. Note that in FIG. 4, the second lower surface 22b is substantially flat, but when the upper surface of the intermediate insulating layer 11c has a curved surface reflected by the recessed curved surface of the first coil wiring layer 21, the second lower surface 22b may have a recessed curved surface gentler than the recessed curved surface of the first coil wiring layer 21.

In the present embodiment, in the parallel arrangement portion 101, the width w2 of the first upper surface 21a of the first coil wiring layer 21 is larger than the width w3 of the second lower surface 22b of the second coil wiring layer 22 facing the first upper surface 21a. In this example, in the X direction, the second lower surface 22b of the second coil wiring layer 22 is located between both edges p1 and p2 of the first upper surface 21a of the first coil wiring layer 21. In other words, in plan view in the axis direction L, in the parallel arrangement portion 101, the second lower surface 22b of the second coil wiring layer 22 is located on an inner side of both edges p1 and p2 of the first upper surface 21a of the first coil wiring layer 21. As described above, since the entire second lower surface 22b is arranged to face a portion recessed from (deeper than) the edges p1 and p2 of the first upper surface 21a of the first coil wiring layer 21, a distance between the first upper surface 21a and the second lower surface 22b in the axis direction L can be made large. Therefore, the interlayer insulating portion 110 can be made further thicker. For example, the minimum thickness (here, a distance from an edge of the second lower surface 22b to the first upper surface 21a) tm of the interlayer insulating portion 110 in the axis direction L can be made larger than a distance tp from the edges p1 and p2 of the first upper surface 21a to the second boundary s2 in the axis direction L. Note that since the edges p1 and p2 are located below the first boundary s1, the distance tp is larger than the thickness T of the intermediate insulating layer 11c (tm>tp>T).

In the example illustrated in FIG. 4, the first upper surface 21a of the first coil wiring layer 21 is a recessed curved surface, and the second lower surface 22b of the second coil wiring layer 22 is substantially flat. Therefore, the thickness of the interlayer insulating portion 110 in the axis direction L increases from both edges p1 and p2 of the second lower surface 22b of the first coil wiring layer 21 toward the central portion side. As an example, a thickness t1 of a first portion, of the interlayer insulating portion 110, located between the central portion (a portion including the lowermost portion located at the lowermost position) of the first upper surface 21a of the first coil wiring layer 21 and the second lower surface 22b of the second coil wiring layer 22 is larger than the thickness, in the axis direction L, of a second portion located further on the edges p1 and p2 side than is the first portion of the interlayer insulating portion 110.

### (Connecting Portion 102)

As illustrated in FIG. 3, the connecting portion 102 includes the first coil wiring layer 21, the second coil wiring layer 22, and the connection conductor (via conductor layer) 26 that electrically connect the first coil wiring layer 21 and the second coil wiring layer 22.

The connection conductor 26 is disposed inside the intermediate insulating layer 11c. Here, the connection conductor 26 is disposed inside a third hole 111c extending through the intermediate insulating layer 11c in a thickness direction. The connection conductor 26 may have a columnar shape. A lower end portion of the connection conductor 26 is connected to the first upper surface 21a of the first coil wiring layer 21, and an upper end portion of the connection conductor 26 is connected to the second lower surface 22b of the second coil wiring layer 22.

In the present embodiment, in a cross section of the connecting portion 102 illustrated in FIG. 3, a width (a width in the X direction) of an upper edge of the first hole 111b formed in the first insulating layer 11b is larger than a width of a lower edge of the third hole 111c formed in the intermediate insulating layer 11c. In addition, a width of an upper edge of the third hole 111c is larger than a width of a lower edge of the second hole 111d formed in the second insulating layer 11d. With such a configuration, even when displacement (alignment displacement of a photomask) occurs at the time of patterning of the insulating layers 11b to 11d, a connection area of the first coil wiring layer 21 and the second coil wiring layer 22 with the connection conductor 26 can be ensured.

The maximum widths (the widths of the upper edges) of the first hole 111b to the third hole 111c may be substantially the same. In this case, in the cross section illustrated in FIG. 3, the shape of the conductor consisting of the first coil wiring layer 21, the connection conductor 26, and the second coil wiring layer 22 can be made closer to a rectangular shape. As a result, a line width of the coil 20 can be suppressed, and DC resistance Rdc of the coil 20 can be reduced.

As illustrated in FIG. 3, the conductor consisting of the first coil wiring layer 21, the connection conductor 26, and the second coil wiring layer 22 may have steps reflected by inner walls of the holes 111b to 111d provided in the respective insulating layers 11b to 11d. For example, a side surface of the conductor has the first surface 261a facing upward on the boundary between the first insulating layer 11b and the intermediate insulating layer 11c. The first surface 261a is in contact with the upper edge of the first hole 111b and can correspond to the upper surface of the first insulating layer 11b, that is, the first boundary s1. Therefore, the imaginary line v (FIG. 4) obtained through extending of the first surface 261a in the X direction can be regarded as the first boundary s1. Similarly, a side surface of the conductor has the second surface 221a facing upward on the boundary between the intermediate insulating layer 11c and the second insulating layer 11d. The second surface 221a can correspond to the upper surface of the intermediate insulating layer 11c, that is, the second boundary s2. An imaginary line obtained through extending of the second surface 221a in the X direction can be regarded as the second boundary s2.

In the example illustrated in FIG. 3, the connection conductor 26 includes a main portion located inside the third hole 111c of the intermediate insulating layer 11c and a lower portion 261 extending downward from the third hole 111c and occupies a portion, of the first hole 111b of the first insulating layer 11b, located above the first coil wiring layer 21. The first surface 261a described above is an upper surface of the lower portion 261. The lower portion 261 of the connection conductor 26 is connected to the first upper surface 21a of the first coil wiring layer 21. Since the first upper surface 21a of the first coil wiring layer 21 is formed from a recessed curved surface, a connection area with the connection conductor 26 can be increased. Therefore, the connection resistance of the connecting portion 102 can be reduced. The upper surface of the main portion of the connection conductor 26 may be located further on a lower side than is the upper surface of the intermediate insulating layer 11c and formed from a recessed curved surface. The “upper surface of the intermediate insulating layer 11c” is, for example, the second boundary s2 between the intermediate insulating layer 11c and the second insulating layer 11d.

In the connecting portion 102, the second coil wiring layer 22 has a lower portion 221 extending downward from the second hole 111d and located inside the third hole 111c of the intermediate insulating layer 11c. The second surface 221a described above is an upper surface of the lower portion 221. The lower portion 221 is connected to the recessed curved surface of the connection conductor 26 inside the third hole 111c. As a result, a connection area of the connection conductor 26 and the second coil wiring layer 22 can be increased.

Note that when the conductor consisting of the first coil wiring layer 21, the connection conductor 26, and the second coil wiring layer 22 is integrated by firing, there is a case in which boundaries of the respective layers are not clear.

### (Manufacturing Method of Inductor Component)

Next, a manufacturing method of the inductor component 1 will be described.

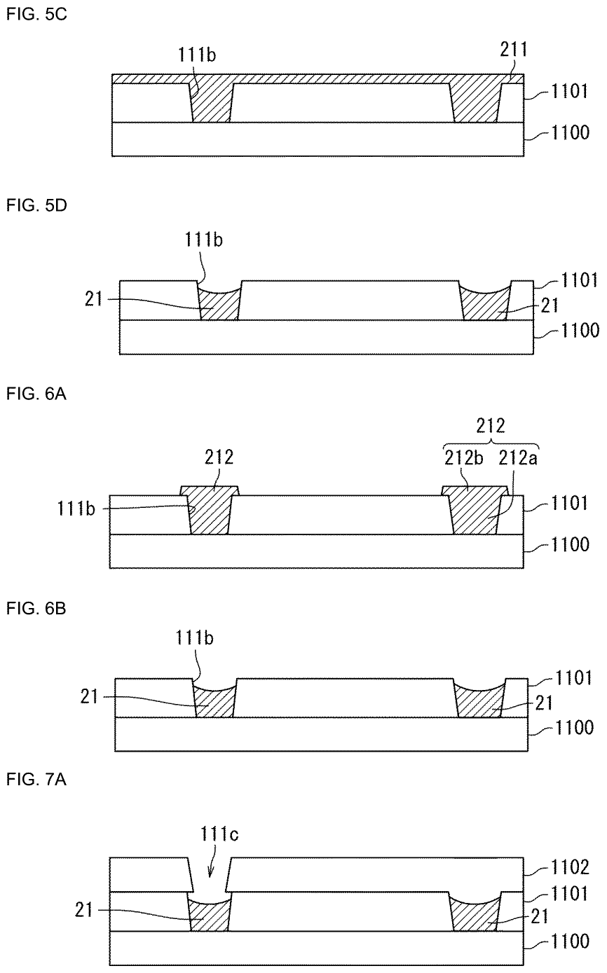

FIGS. 5A to 5D, FIGS. 6A to 6B, and FIGS. 7A to 7D are process sectional views each illustrating a manufacturing method of the inductor component. These figures are sectional views corresponding to FIG. 3 and illustrate regions in which the connecting portion and the parallel arrangement portion are formed. Here, the first coil wiring layer and the second coil wiring layer will be described as examples, but other coil wiring layers can be formed by a similar method.

### Formation of First Coil Wiring Layer 21

As illustrated in FIG. 5A, for example, using a negative-type photosensitive insulating paste, a first insulating material layer 1101 is formed on an insulating material layer 1100. The first insulating material layer 1101 is formed through applying of the insulating paste on an upper surface of the insulating material layer 1100. The insulating paste is applied by, for example, screen printing.

The photosensitive insulating paste contains, for example, a glass material, a filler material, and a photosensitive organic component. Filler means inorganic particles that exist as particles without being softened in a firing temperature range. Various ceramic materials can be used as the filler. The filler material is, for example, quartz (crystal quartz). The filler material may be, for example, crystallized glass, alumina, titania, zirconia, ceria, or the like other than quartz. The glass material is, for example, borosilicate glass. The glass material may be, other than borosilicate glass, for example, glass containing SiO₂, B₂O₃, K₂O, Li₂O, CaO, ZnO, Bi₂O₃, and/or Al₂O₃, or the like, for example, SiO₂—B₂O₃—K₂O-based glass, SiO₂—B₂O₃—Li₂O—CaO-based glass, SiO₂—B₂O₃—Li₂O—CaO—ZnO-based glass, or Bi₂O₃—B₂O₃—SiO₂—Al₂O₃-based glass. Two or more of these inorganic components may be combined. Note that a positive-type photosensitive insulating paste may be used.

Next, as illustrated in FIG. 5B, a part of the first insulating material layer 1101 is removed by a method such as photolithography so that the first hole 111b extending through the first insulating material layer 1101 in the thickness direction is formed. The first hole 111b is disposed so as to extend in a direction orthogonal to the axis direction L. Note that as the first hole 111b, a groove (bottomed hole) may be formed instead of a through hole.

Subsequently, as illustrated in FIG. 5C, a conductive material is deposited inside the first hole 111b and on the first insulating material layer 1101 so as to form a conductive layer 211. As an example, the conductive layer 211 is formed through applying of a conductive paste by screen printing. Alternatively, the conductive layer 211 may be formed by application using a micro-dispenser, a spin coater, a slit coater, or the like.

Then, as illustrated in FIG. 5D, the conductive layer 211 is processed such that the coil wiring layer 21 located below the upper surface of the first insulating material layer 1101 and having an upper surface formed from a recessed curved surface is obtained. Although the processing method of the conductive layer 211 is not particularly limited, but laser processing can be used, for example.

The formation method of the first coil wiring layer 21 is not limited to the method illustrated in FIGS. 5C and 5D. As illustrated in FIG. 6A, after the first hole 111b is formed, a conductive portion 212 having a pattern along the first hole 111b may be formed. The conductive portion 212 includes a portion (hereinafter, referred to as a “main portion”) 212a located inside the first hole 111b and a portion (hereinafter, referred to as a “lid portion”) 212b extending upward from the first hole 111b. A width of the lid portion 212b is larger than the width of the first hole 111b. A peripheral portion of the lid portion 212b may be in contact with the upper surface of the first insulating material layer 1101. The conductive portion 212 may be formed by, for example, screen printing of a conductive paste, or may be formed through processing of the conductive layer 211 illustrated in FIG. 5C by, for example, photolithography or the like.

Subsequently, as illustrated in FIG. 6B, the conductive portion 212 is processed by, for example, laser processing so that the entire lid portion 212b of the conductive portion 212 and an upper portion of the main portion 212a are removed. As described above, the coil wiring layer 21 having an upper surface formed from a recessed curved surface is obtained.

### Formation of Connection Conductor 26

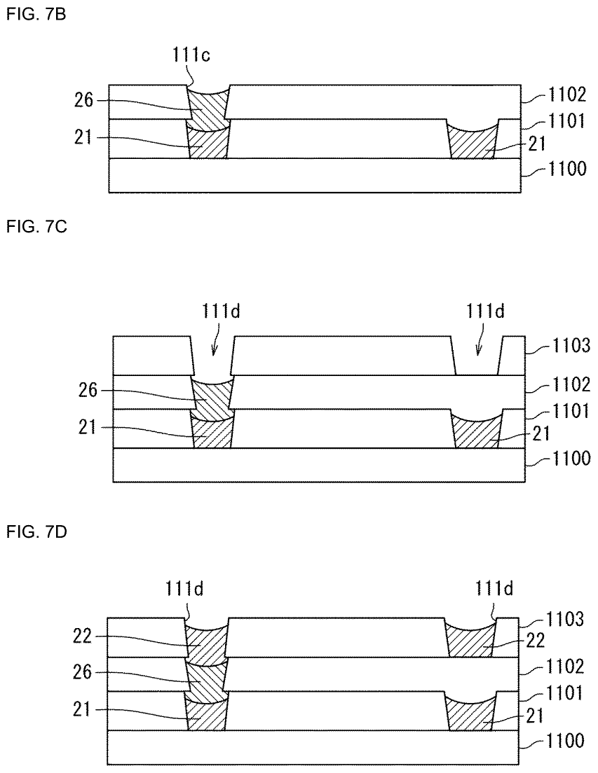

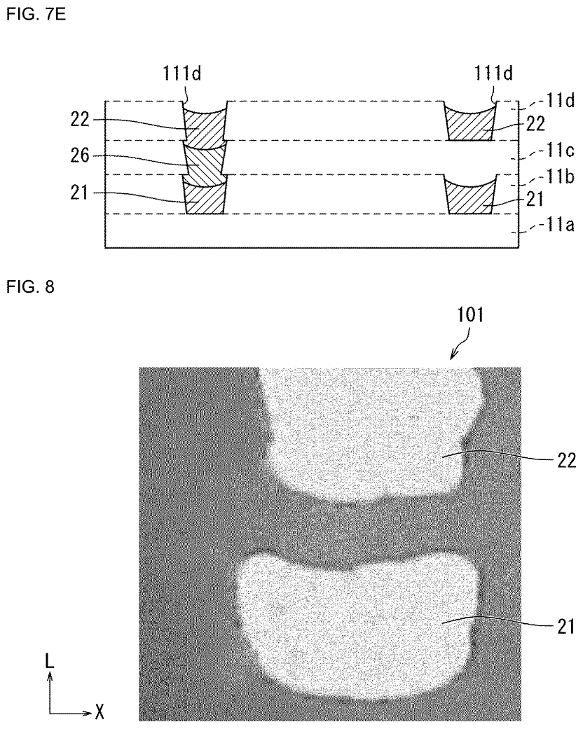

After the coil wiring layer 21 is formed, as illustrated in FIG. 7A, an intermediate insulating material layer 1102 is formed on the first insulating material layer 1101 and the first coil wiring layer 21. The intermediate insulating material layer 1102 is formed by a similar method and using a similar insulating paste to the first insulating material layer 1101. Then, the third hole 111c through which a part of the first coil wiring layer 21 is exposed is formed in a region, of the intermediate insulating material layer 1102, in which the connecting portion is formed by, for example, photolithography. The third hole 111c is not formed in the parallel arrangement portion.

Subsequently, as illustrated in FIG. 7B, the connection conductor 26 is formed inside the third hole 111c. The connection conductor 26 may be formed using the same material as and by a similar method to the first coil wiring layer 21. As a result, the connection conductor 26 located below the upper surface of the intermediate insulating material layer 1102 and having an upper surface formed from a recessed curved surface is obtained.

### Formation of Second Coil Wiring Layer 22

Subsequently, as illustrated in FIG. 7C, a second insulating material layer 1103 is formed on the intermediate insulating material layer 1102 and the connection conductor 26. The second insulating material layer 1103 is also formed using a similar insulating paste and by a similar method to the first insulating material layer 1101. Then, the second hole 111d through which a part of the connection conductor 26 is exposed is formed in the second insulating material layer 1103 by, for example, photolithography. The second hole 111d is disposed so as to extend in the direction orthogonal to the axis direction L.

Subsequently, as illustrated in FIG. 7D, the second coil wiring layer 22 is formed in the second hole 111d. The second coil wiring layer 22 may be formed using the same material as and by a similar method to the first coil wiring layer 21. As a result, the second coil wiring layer 22 located below the upper surface of the second insulating material layer 1103 and having an upper surface formed from a recessed curved surface is obtained. The second coil wiring layer 22 is electrically connected to the connection conductor 26 in the connecting portion and faces the first coil wiring layer 21 with the intermediate insulating material layer 1102 interposed therebetween in the facing portion (here, the parallel arrangement portion).

As described above, the formation process of the insulating layers and the formation process of the coil wiring layers or the connection conductor are repeated a predetermined number of times. Then, the obtained multilayer body is fired. As a result, as illustrated in FIG. 7E, the insulating layers 11a to 11d containing a glass component and a filler component are formed from the insulating material layers 1101 to 1103. Organic components contained in the insulating paste can be eliminated by firing. Therefore, the insulating layers 11a to 11d after firing do not have to substantially contain organic components. As described above, the inductor component 1 is manufactured.

### (Effects)

According to the inductor component 1 of the present embodiment, as illustrated in FIG. 4, in a cross section orthogonal to the extending direction of the first coil wiring layer 21, the first upper surface 21a of the first coil wiring layer 21 located on the interlayer insulating portion 110 side is formed from a curved surface recessed from the both edges p1 and p2 of the first upper surface 21a in a direction opposite to the second coil wiring layer 22 in the axis direction L. With such a configuration, while an increase in thickness of the body 10 is suppressed, the thickness of the interlayer insulating portion 110 can be increased, as a result of which the insulation reliability between the first coil wiring layer 21 and the second coil wiring layer 22 can be enhanced. Therefore, for example, a failure such as a reduction in yield due to inability of obtaining desired inductance caused by electrical conduction between the coil wiring layers can be suppressed.

In addition, according to the above-described configuration, since the first upper surface 21a of the first coil wiring layer 21 is formed from a recessed curved surface, the thickness of a portion, of the first coil wiring layer 21, located on a coil inner diameter side where a current easily concentrates can be made larger than the thickness of the central portion including the bottom portion of the recessed curved surface. As a result, an increase in resistance of the coil 20 in a case of a high frequency can be suppressed. Note that the central portion of the first coil wiring layer 21 is thin due to a recess of the recessed curved surface, but the recess in the central portion where current concentration does not easily occur does not considerably affect the resistance in a case of a high frequency. Therefore, through forming of a recessed curved surface, an increase in resistance of the coil 20 in a case of a high frequency is suppressed, and the interlayer insulating portion 110 can be made thick so that the insulation reliability can be enhanced.

In addition, according to the inductor component 1, as illustrated in FIG. 4, the width w2 of the first upper surface 21a of the first coil wiring layer 21 is larger than the width w1 of the first lower surface 21b of the first coil wiring layer 21. According to such a configuration, through increasing of a width on the first upper surface 21a side on which a recessed curved surface is formed, while the area of the recessed curved surface can be increased, a decrease in sectional area of the first coil wiring layer 21 can be suppressed. Since the area of the recessed curved surface can be increased, the recessed curved surface and the second coil wiring layer 22 are easily caused to face each other. Therefore, by using the recessed curved surface, the insulation between the coil wiring layers can be more reliably enhanced. In addition, since a decrease in wiring sectional area of the first coil wiring layer 21 can be suppressed, while the thickness of the first coil wiring layer 21 is not increased, an increase in resistance of the first coil wiring layer 21 can be suppressed. As a result, an effect of reducing the DC resistance Rdc of the coil 20 can be obtained.

Moreover, in the inductor component 1, as illustrated in FIG. 4, in the parallel arrangement portion of the first coil wiring layer 21 and the second coil wiring layer 22, the width w2 of the first upper surface 21a of the first coil wiring layer 21 is larger than the width w3 of the second lower surface 22b of the second coil wiring layer 22. With such a configuration, the second lower surface 22b of the second coil wiring layer 22 is easily caused to face a deeper portion (a portion located lower) of the first upper surface 21a of the first coil wiring layer 21. Therefore, the distance between the coil wiring layers 21 and 22 can be made larger, that is, the interlayer insulating portion 110 can be made thicker.

In plan view of the parallel arrangement portion 101 in the axis direction L, the second lower surface 22b of the second coil wiring layer 22 may be located on an inner side of the two edges p1 and p2 of the first upper surface 21a of the first coil wiring layer 21. With such a configuration, the thickness of the interlayer insulating portion 110 can be further increased.

In the inductor component 1, the body 10 includes the plurality of insulating layers 11 stacked in the axis direction L. The plurality of insulating layers 11 includes the first insulating layer 11b, the second insulating layer 11d, and the intermediate insulating layer 11c located between the first insulating layer 11b and the second insulating layer 11d in the axis direction L. The first coil wiring layer 21 is disposed inside the first insulating layer 11b, and the second coil wiring layer 22 is disposed inside the second insulating layer 11d. The intermediate insulating layer 11c includes the interlayer insulating portion 110. At least a part of the interlayer insulating portion 110 has a portion projecting toward the first insulating layer 11b side. The first upper surface 21a of the first coil wiring layer 21 is in contact with the portion of the interlayer insulating portion 110 projecting toward the first insulating layer 11b side. The first upper surface 21a is also located further on a lower side than is the upper surface (the first boundary s1) of the first insulating layer 11b in the axis direction L, that is, further on a side opposite to the second coil wiring layer 22 side than is the upper surface of the first insulating layer 11b. As described above, since the first upper surface 21a of the first coil wiring layer 21 is located further on a lower side than is the upper surface of the first insulating layer 11b, the distance between the first upper surface 21a of the first coil wiring layer 21 and the second lower surface 22b of the second coil wiring layer 22 can be made large. Therefore, while the total thickness of the body 10 is suppressed, the interlayer insulating portion 110 can be made thicker, and the insulation reliability between the coil wiring layers can be further enhanced.

Each of the insulating layers 11 (including the interlayer insulating portion 110) is formed using a photosensitive material (insulating paste) containing a filler material and a glass material. The insulating layer 11 may be a fired product of such an insulating paste. The insulating layer 11 after firing can contain a glass component or a filler component. Through using of a photosensitive insulating paste, each insulating layer 11 can be processed by photolithography. Through using of photolithography, positional displacement (alignment displacement of a mask) between the stacked plurality of insulating layers 11 can be suppressed to be substantially small with respect to the line width of the respective coil wiring layers.

### Example and Reference Example

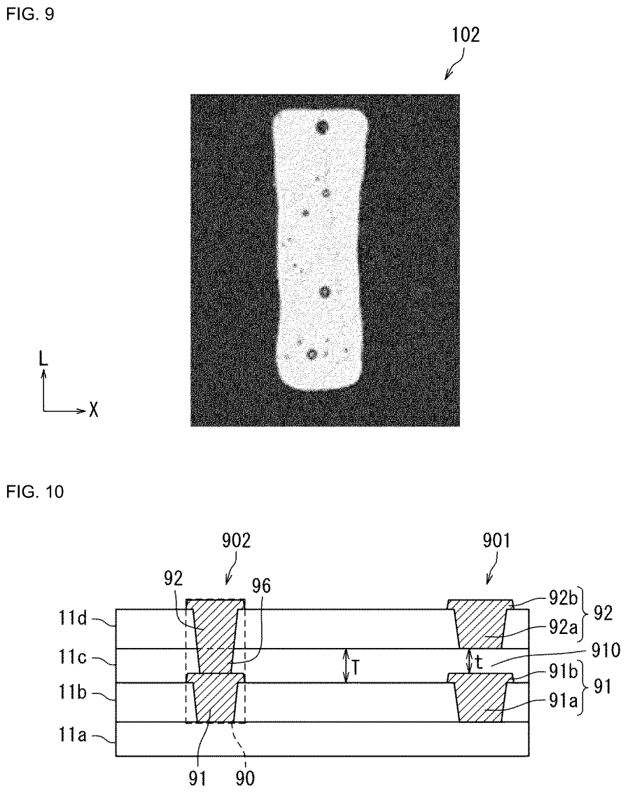

As an example, the inductor component 1 illustrated in FIGS. 1A to 4 is manufactured, and cross sections of a parallel arrangement portion and a connecting portion are observed. FIG. 8 is an electron microscope image illustrating an example of a cross section of a parallel arrangement portion of the inductor component 1. FIG. 9 is an electron microscope image illustrating an example of a cross section of a connecting portion of the inductor component 1.

It can be understood from the cross section of the parallel arrangement portion 101 illustrated in FIG. 8 that the upper surface of the first coil wiring layer 21 is formed from a recessed curved surface. In addition, side surfaces of the first coil wiring layer 21 and the second coil wiring layer 22 are substantially smooth. Moreover, it can be understood from the cross section of the connecting portion 102 illustrated in FIG. 9 that the conductor consisting of the first coil wiring layer 21, the connection conductor 26, and the second coil wiring layer 22 has a substantially rectangular shape.

For comparison, an inductor component of a reference example is manufactured, and a cross section is observed in a similar manner.

FIG. 10 is a schematic sectional view illustrating a parallel arrangement portion and a connecting portion of the inductor component of the reference example. As illustrated in FIG. 10, in a parallel arrangement portion 901 of the reference example, a coil wiring layer 92 is disposed above a coil wiring layer 91 with an interlayer insulating portion 910 interposed therebetween. The coil wiring layer 91 includes a portion (hereinafter, a “main portion”) 91a located inside a through hole formed in the first insulating layer 11b and a portion (hereinafter, a “lid portion”) 91b located above the first insulating layer 11b. The width of the lid portion 91b is larger than the width of the main portion 91a. Similarly, the coil wiring layer 92 also includes a main portion 92a disposed inside a through hole of the second insulating layer 11d and a lid portion 92b located above the second insulating layer 11d. The interlayer insulating portion 910 is a part of the intermediate insulating layer 11c. In a connecting portion 902, a connection conductor 96 connecting the coil wiring layer 91 and the coil wiring layer 92 is disposed inside a hole extending through the intermediate insulating layer 11c.

In the reference example, since the intermediate insulating layer 11c is formed so as to cover the lid portion 91b of the coil wiring layer 91, a portion, of the intermediate insulating layer 11c, located above the lid portion 91b may become thinner than other portions of the intermediate insulating layer 11c. As a result, a thickness t of the interlayer insulating portion 910 may be smaller than the thickness T of the intermediate insulating layer 11c.

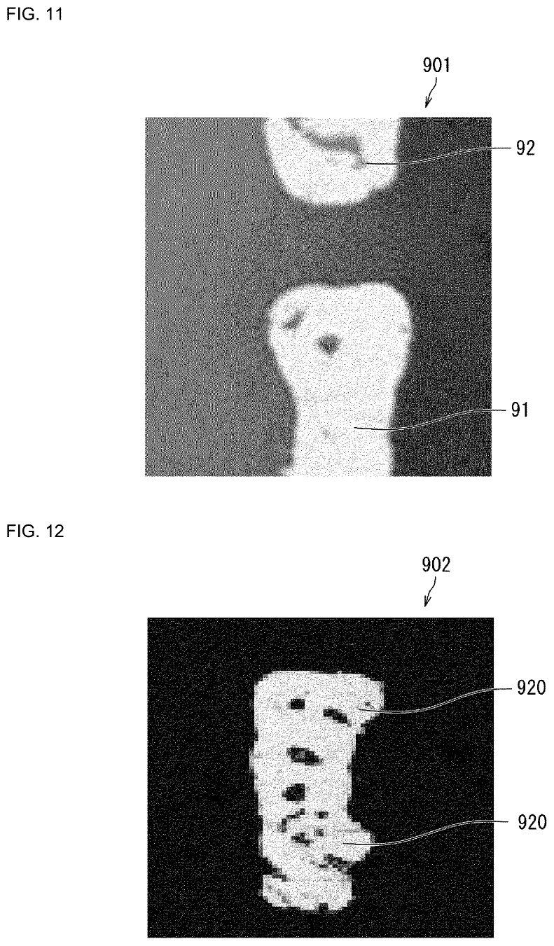

FIGS. 11 and 12 are electron microscope images illustrating cross sections of the parallel arrangement portion and the connecting portion of the inductor component of the reference example. It can be understood from the cross section illustrated in FIG. 11 that, in the reference example, the upper surface of the coil wiring layer 91 (the upper surface of the lid portion 91b) is substantially flat. In addition, as understood from FIGS. 11 and 12, protruding portions 920 due to the lid portions 91b and 92b are formed on side surfaces of the coil wiring layers 91 and 92. The protruding portions 920 project in the direction orthogonal to the axis direction L.

The inductor component 1 of the example can have the following advantages over the inductor component of the reference example.

As described earlier with reference to FIG. 10, in the inductor component of the reference example, since the intermediate insulating layer 11c is made thin, the interlayer insulating portion 910 between the coil wiring layers become thin, and there is a case in which desired insulation cannot be obtained. On the other hand, in the inductor component 1 of the example, since the upper surface of the first coil wiring layer 21 is located further on a lower side than is the upper surface of the first insulating layer 11b, and the upper surface of the coil wiring layer 21 is a recessed curved surface, the interlayer insulating portion 110 having a desired thickness can be more reliably formed. The thickness of the interlayer insulating portion 110 can be made larger than, for example, the thickness T of the intermediate insulating layer 11c. Therefore, while the thickness of each of the insulating layers 11 is not increased, the insulation between the coil wiring layers can be enhanced.

In addition, as illustrated in FIGS. 8 and 9, in the inductor component 1, side surfaces of the coil wiring layers 21 and 22 are not formed from protruding portions like the ones in the reference example (see FIGS. 11 and 12) and are smooth. Therefore, a decrease in effective coil inner diameter due to the protruding portions can be suppressed. In addition, an increase in AC resistance Rac due to the protruding portions can be suppressed. In the reference example, the lid portions 91b and 92b (the protruding portions 920) hinder magnetic flux of a coil inner diameter portion, and the Q characteristics may be deteriorated. On the other hand, according to the inductor component 1 of the example, since the side surfaces of the coil wiring layers 21 and 22 are smooth, deterioration of the Q characteristics due to the protruding portions can be suppressed.

Moreover, in the reference example, as illustrated in FIG. 10, it is difficult to increase a ratio occupied by the sectional area of the conductor, of the connecting portion 902, consisting of the two coil wiring layers 91 and 92, and the connection conductor 96 in the sectional area of a rectangle 90 consisting of the maximum width (for example, the width of the lid portion 92b) and the height of the conductor. On the other hand, in the example, the conductor of the connecting portion 102 is substantially rectangular, and the above-described ratio can be made higher than the reference example. Therefore, since the wiring sectional area can be increased while the line width is suppressed, the DC resistance Rdc can be reduced.

### Modifications

Note that the present disclosure is not limited to the above-described embodiment, and various changes in design are conceivable without departing from the gist of the present disclosure.

In the inductor component of the present disclosure, the first upper surface 21a of the first coil wiring layer 21 may have an upper surface formed from a recessed curved surface, as a result of which an effect of enhancing the insulation reliability of the interlayer insulating portion 110 is exhibited. In the example illustrated in FIG. 3, the entire first upper surface 21a of the first coil wiring layer 21 is located further on a lower side than is the upper surface of the first insulating layer 11b, but only a part of the first upper surface 21a of the first coil wiring layer 21 may be located further on an upper side than is the upper surface of the first insulating layer 11b. Alternatively, the first coil wiring layer 21 may have a lid portion located above the first insulating layer 11b, and an upper surface of the lid portion may be formed from a recessed curved surface.

The connection conductor 26 and the second coil wiring layer 22 may also have portions located further on an upper side than is the upper surfaces of the insulating layers 11c and 11d, respectively. In addition, the upper surfaces of the connection conductor 26 and the second coil wiring layer 22 do not have to be recessed curved surfaces, and may be, for example, substantially flat.

The shapes, arrangement, the number (the number of stacked layers), and the like of the coil wiring layers, the connection conductors, and the insulating layers are not limited to the example illustrated in FIGS. 1A and 1B. For example, in the example illustrated in FIGS. 1A and 1B, the coil 20 has a configuration in which a plurality of coil wiring layers whose number of turns of is less than one is stacked, but the number of turns of the coil wiring layers may be equal to or more than one. That is, the respective coil wiring layers may have a plane spiral shape. In addition, in FIGS. 1A and 1B, the axis direction L of the coil (the stacking direction A of the insulating layers) is parallel to the bottom surface (mounting surface) of the inductor component, but the axis direction L of the coil may be a direction orthogonal to the bottom surface and the top surface of the inductor component. Moreover, the shapes and arrangement of the first and the second outer electrodes are not particularly limited.

The materials and the formation methods of the respective constituents of the inductor component are also not particularly limited to the above-described examples. For example, a colorant such as cobalt may be added to the body so as to reduce the transmittance of the product. As a result, visibility of the coil inside can be reduced. In addition, it is also possible to use different materials between the coil wiring layers and the connection conductors.

The above-described description can also be expressed as below.

An inductor component of the first aspect including an insulating body; and a coil disposed inside the body and wound around an axis. The coil includes a first coil wiring layer that extends in a direction intersecting with a first direction parallel to the axis, and a second coil wiring layer that is disposed away from the first coil wiring layer in the first direction and extends in the direction intersecting with the first direction. The first coil wiring layer and the second coil wiring layer configure a facing portion in which the first coil wiring layer and the second coil wiring layer face each other with an interlayer insulating portion interposed therebetween, the interlayer insulating portion being a part of the body. In a cross section, of the facing portion, orthogonal to an extending direction of the first coil wiring layer, the first coil wiring layer has a first upper surface that is located on an interlayer insulating portion side and that is formed from a curved surface recessed from both edges of the first upper surface in a direction opposite to the second coil wiring layer in the first direction.

The inductor component of the second aspect, in the inductor component of the first aspect, in which in a cross section, of the facing portion, orthogonal to the extending direction of the first coil wiring layer, a width of the first upper surface of the first coil wiring layer in a direction orthogonal to the first direction is larger than a width of a first lower surface of the first coil wiring layer in the direction orthogonal to the first direction, the first lower surface being located on a side opposite to the interlayer insulating portion side.

The inductor component of the third aspect, in the inductor component of the first or the second aspect, in which the facing portion includes a parallel arrangement portion in which the first coil wiring layer and the second coil wiring layer extend in a same direction with the interlayer insulating portion interposed therebetween. Also, in a cross section, of the parallel arrangement portion, orthogonal to the extending direction of the first coil wiring layer, a width of the first upper surface in a direction orthogonal to the first direction is larger than a width of a second lower surface of the second coil wiring layer in the direction orthogonal to the first direction, a second lower surface being located on the interlayer insulating portion side.

The inductor component of the fourth aspect, in the inductor component of the third aspect, in which in a cross section, of the parallel arrangement portion, orthogonal to the extending direction of the first coil wiring layer, a thickness of the interlayer insulating portion in the first direction increases from both edges of the second lower surface toward a central portion side.

The inductor component of the fifth aspect, in the inductor component of the third or the fourth aspect, in which in plan view in the first direction, in the parallel arrangement portion, the second lower surface of the second coil wiring layer is located on an inner side of both the edges of the first upper surface of the first coil wiring layer.

The inductor component of the sixth aspect, in the inductor component of any one of the first to the fifth aspects, in which in a cross section orthogonal to the extending direction of the first coil wiring layer, the first coil wiring layer includes the first upper surface, a first lower surface located at a position, of the first coil wiring layer, on a side opposite to the interlayer insulating portion side, and a side surface connecting the first upper surface and the first lower surface. Also, the side surface of the first coil wiring layer is smooth.

The inductor component of the seventh aspect, in the inductor component of any one of the first to the sixth aspects, further including a connection conductor that electrically connects a part of the first coil wiring layer and a part of the second coil wiring layer, in which the connection conductor is disposed inside a hole extending through the interlayer insulating portion in the first direction.

The inductor component of the eighth aspect, in the inductor component of any one of the first to the seventh aspects, in which the interlayer insulating portion contains a filler material and a glass material.

The inductor component of the ninth aspect, in the inductor component of any one of the first to the eighth aspects, in which the body includes a plurality of insulating layers stacked in the first direction. Also, the plurality of insulating layers includes a first insulating layer, a second insulating layer, and an intermediate insulating layer located between the first insulating layer and the second insulating layer in the first direction. In addition, the first coil wiring layer is disposed inside the first insulating layer, the second coil wiring layer is disposed inside the second insulating layer, the intermediate insulating layer includes the interlayer insulating portion located between the first coil wiring layer and the second coil wiring layer, at least a part of the interlayer insulating portion has a portion projecting toward a first insulating layer side, and the first upper surface of the first coil wiring layer is in contact with the portion of the interlayer insulating portion projecting toward the first insulating layer side and is located further on a side opposite to a second coil wiring layer side than is an upper surface of the first insulating layer in the first direction.

The inductor component of the present disclosure has a highly insulating property between coil wiring layers and thus is used as, for example, an impedance matching coil (matching coil) of a high-frequency circuit and is used for an electronic device such as a personal computer, a DVD player, a digital camera, a TV, a mobile phone, automotive electronics, and medical and industrial machinery. The inductor component of the present disclosure can also be suitably used for a tuning circuit, a filter circuit, a rectification smoothing circuit, or the like.

What is claimed is:

1. An inductor component comprising:
an insulating body; and
a coil inside the body and wound around an axis, wherein
the coil includes
a first coil wiring layer that extends in a direction intersecting with a first direction parallel to the axis, and
a second coil wiring layer that is away from the first coil wiring layer in the first direction and extends in the direction intersecting with the first direction,
the first coil wiring layer and the second coil wiring layer configure a facing portion in which the first coil wiring layer and the second coil wiring layer face each other with an interlayer insulating portion interposed therebetween, the interlayer insulating portion being a part of the body, and
in a cross section, of the facing portion, orthogonal to an extending direction of the first coil wiring layer, the first coil wiring layer has a first upper surface that is on an interlayer insulating portion side and, the first upper surface is defined as a curved surface recessed from both edges of the first upper surface in a direction opposite to the second coil wiring layer in the first direction.

2. The inductor component according to claim 1, wherein
in a cross section, of the facing portion, orthogonal to the extending direction of the first coil wiring layer, a width of the first upper surface of the first coil wiring layer in a direction orthogonal to the first direction is larger than a width of a first lower surface of the first coil wiring layer in the direction orthogonal to the first direction, the first lower surface being on a side opposite to the interlayer insulating portion side.

3. The inductor component according to claim 1, wherein
the facing portion includes a parallel arrangement portion in which the first coil wiring layer and the second coil wiring layer extend in a same direction with the interlayer insulating portion interposed therebetween, and
in a cross section, of the parallel arrangement portion, orthogonal to the extending direction of the first coil wiring layer, a width of the first upper surface of the first coil wiring layer in a direction orthogonal to the first direction is larger than a width of a second lower surface of the second coil wiring layer in the direction orthogonal to the first direction, the second lower surface being on the interlayer insulating portion side.

4. The inductor component according to claim 3, wherein
in a cross section, of the parallel arrangement portion, orthogonal to the extending direction of the first coil wiring layer, a thickness of the interlayer insulating portion in the first direction increases from both edges of the second lower surface toward a central portion side.

5. The inductor component according to claim 3, wherein
in plan view in the first direction, in the parallel arrangement portion, the second lower surface of the second coil wiring layer is on an inner side of both the edges of the first upper surface of the first coil wiring layer.

6. The inductor component according to claim 1, wherein
in a cross section orthogonal to the extending direction of the first coil wiring layer, the first coil wiring layer includes the first upper surface, a first lower surface of the first coil wiring layer at a position on a side opposite to the interlayer insulating portion side, and a side surface connecting the first upper surface and the first lower surface, and
the side surface of the first coil wiring layer is smooth.

7. The inductor component according to claim 1, further comprising
a connection conductor that electrically connects a part of the first coil wiring layer and a part of the second coil wiring layer, wherein
the connection conductor is inside a hole extending through the interlayer insulating portion in the first direction.

8. The inductor component according to claim 1, wherein
the interlayer insulating portion includes a filler material and a glass material.

9. The inductor component according to claim 1, wherein
the body includes a plurality of insulating layers stacked in the first direction,
the plurality of insulating layers includes
a first insulating layer,
a second insulating layer, and
an intermediate insulating layer between the first insulating layer and the second insulating layer in the first direction,
the first coil wiring layer is inside the first insulating layer,
the second coil wiring layer is inside the second insulating layer,
the intermediate insulating layer includes the interlayer insulating portion between the first coil wiring layer and the second coil wiring layer,
at least a portion of the interlayer insulating portion has a portion projecting toward a first insulating layer side, and
the first upper surface of the first coil wiring layer is in contact with the portion of the interlayer insulating portion projecting toward the first insulating layer side and is further on a side opposite to a second coil wiring layer side than is an upper surface of the first insulating layer in the first direction.

10. The inductor component according to claim 2, wherein
the facing portion includes a parallel arrangement portion in which the first coil wiring layer and the second coil wiring layer extend in a same direction with the interlayer insulating portion interposed therebetween, and
in a cross section, of the parallel arrangement portion, orthogonal to the extending direction of the first coil wiring layer, a width of the first upper surface of the first coil wiring layer in a direction orthogonal to the first direction is larger than a width of a second lower surface of the second coil wiring layer in the direction orthogonal to the first direction, the second lower surface being on the interlayer insulating portion side.

11. The inductor component according to claim 10, wherein
in a cross section, of the parallel arrangement portion, orthogonal to the extending direction of the first coil wiring layer, a thickness of the interlayer insulating portion in the first direction increases from both edges of the second lower surface toward a central portion side.

12. The inductor component according to claim 10, wherein
in plan view in the first direction, in the parallel arrangement portion, the second lower surface of the second coil wiring layer is on an inner side of both the edges of the first upper surface of the first coil wiring layer.

13. The inductor component according to claim 2, wherein
in a cross section orthogonal to the extending direction of the first coil wiring layer, the first coil wiring layer includes the first upper surface, a first lower surface of the first coil wiring layer at a position on a side opposite to the interlayer insulating portion side, and a side surface connecting the first upper surface and the first lower surface, and
the side surface of the first coil wiring layer is smooth.

14. The inductor component according to claim 2, further comprising
a connection conductor that electrically connects a part of the first coil wiring layer and a part of the second coil wiring layer, wherein
the connection conductor is inside a hole extending through the interlayer insulating portion in the first direction.

15. The inductor component according to claim 2, wherein
the interlayer insulating portion includes a filler material and a glass material.

16. The inductor component according to claim 2, wherein
the body includes a plurality of insulating layers stacked in the first direction,
the plurality of insulating layers includes
a first insulating layer,
a second insulating layer, and
an intermediate insulating layer between the first insulating layer and the second insulating layer in the first direction,
the first coil wiring layer is inside the first insulating layer,
the second coil wiring layer is inside the second insulating layer,
the intermediate insulating layer includes the interlayer insulating portion between the first coil wiring layer and the second coil wiring layer,
at least a portion of the interlayer insulating portion has a portion projecting toward a first insulating layer side, and
the first upper surface of the first coil wiring layer is in contact with the portion of the interlayer insulating portion projecting toward the first insulating layer side and is further on a side opposite to a second coil wiring layer side than is an upper surface of the first insulating layer in the first direction.
